(19) United States
(12) Patent Application Publication
(10) Pub. No.: US 2021/0345780 A1
(43) Pub. Date: Nov. 11, 2021

(54) Privacy/Protective Headrest Assembly

(71) Applicants: Robert Clough, Santa Fe Springs, CA (US); Sergio Millan, Santa Fe Springs, CA (US)

(72) Inventors: Robert Clough, Santa Fe Springs, CA (US); Sergio Millan, Santa Fe Springs, CA (US)

(21) Appl. No.: 17/317,537

(22) Filed: May 11, 2021

Related U.S. Application Data
(60) Provisional application No. 63/022,916, filed on May 11, 2020.

(51) Int. Cl. A47C 7/38; B60N 2/885; B64D 11/06

(52) U.S. Cl. CPC A47C 7/38; B64D 11/0606; B60N 2/885

(57) ABSTRACT

A fully adjustable privacy/protective headrest with foldable protective wings for use in connection with furniture and with passenger vehicles such as aircraft, trains, and buses.

### CROSS-REFERENCE TO RELATED APPLICATIONS

This is a Non-Provisional application claiming the benefit of co-pending Provisional Application No. 63/022,916 filed May 11, 2020.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

The present invention relates generally to headrests for seats. More particularly, the invention concerns a fully adjustable privacy/protective headrest with foldable protective wings for use in connection with furniture and with passenger vehicles such as aircraft, trains, and buses.

### Discussion of the Prior Art

Various types of headrests for use in passenger vehicles have been suggested in the past. As the genera rule, these headrests are designed primarily to satisfy comfort aspects rather than to provide a privacy and personal protection from neighboring seats. Typically, the prior art vehicle headrests comprise only a vertically adjustable head support member designed to provide protection against injury in the event of an accident. However, some vehicle headrests have also been provided with lateral headrest elements.

In addition to passenger vehicle headrests, a number of headrests have been designed for use in emergency vehicles. These types of headrests are of a more complicated design and some include greater adjustability features. Exemplary of these types of headrests are those disclosed in U.S. Pat. Nos. 5,275,462 and 5,934,749, both issued to Pond et al.

Even more complex headrests have been designed for use in military aircraft and, more particularly in military aircraft for use in conjunction with ejection seats. Typical of this class of headrest design are those disclosed in U.S. Pat. Nos. 4,883,243 and 4,899,961.

In addition to the development of headrests for use in military aircraft, significant advances have been made in recent years in the design of headrests for use in commercial aircraft. Many of these headrests re designed for personal comfort and include pivotally movable back and lateral supports. In these latter types of headrests, the head support members are typically slidably mounted on spaced apart rods that extend upwardly from the back of the seat and rely on friction to maintain the headrest in an elevated position.

As will become clear from the discussion that follows, the headrest of the present invention represents a substantial improvement over the prior art headrests and in addition to providing greater comfort and safety, also provides privacy and protection for the user. More particularly, the headrest of the present invention incorporates large foldable wings that unfold to provide privacy and personal protection for the occupant.

### SUMMARY OF THE INVENTION

It is an object of the present invention to provide a vertically adjustable headrest that provides both support and comfort to the user and one that is suitable for use in connection with various types of passenger vehicles, including commercial aircraft.

Another object of the invention is to provide a headrest of the aforementioned character that uniquely includes adjustable means for providing privacy, comfort and personal protection for the user.

Another object of the invention is to provide a headrest as described in the preceding paragraph in which the means for providing privacy includes adjustable wing like supports that swing outwardly from a folded stowed position into a 90 degree outward position. More particularly, by providing specially configured transverse head supports and adjustable wing like supports, a privacy zone can be created within which the user's head can be isolated.

Another object of the invention is to provide a privacy/protective headrest as described in the preceding paragraphs in which the central head portion panel and the adjustable wing like supports are of a strategic length that will create a privacy zone within which the user's head can safely and comfortably reside. More particularly, in the preferred form of the invention, the central head portion panel preferably has a length of between about 19 inches and about 21 inches and the wing like supports preferably have a length of between about 9.6 inches and about 10.6 inches.

Another object of the invention is to provide a headrest as described in the preceding paragraphs in which the adjustable wings are pivotally connected to a vertically adjustable head support member by means of a friction hinge.

### BRIEF DESCRIPTION OF THE DRAWINGS

FIG. 1 is generally perspective view of one form of the adjustable headrest of the invention showing the foldable wings in a stowed, overlapping position.

FIG. 2 is a generally perspective view of the adjustable headrest of FIG. 1, showing the foldable wings in a deployed position.

FIG. 3 is a generally perspective, illustrative view of the headrest as it functions to provide privacy to the passenger when the folded wings are in the deployed position.

FIG. 4 is a generally perspective, exploded front view of the headrest of FIG. 1.

FIG. 5 is a generally perspective, exploded rear view of the headrest of FIG. 1.

FIG. 6 is a generally perspective fragmentary rear view of the structural components of the headrest of FIG. 1 showing the elongated guide of the seat connector assembly in position with the spaced apart roller assemblies of de user support assembly.

FIG. 7 is a generally perspective exploded front view similar to FIG. 2, but showing the foldable wings spaced apart from the transverse support member.

FIG. 8 is a generally perspective view of an alternate form of the adjustable headrest of the invention showing the foldable wings in a stowed, end to end position.

FIG. 9 is a generally perspective view of the adjustable headrest of FIG. 8, showing the foldable wings in a deployed position.

FIG. 10 is a generally perspective, exploded front view of the headrest of FIG. 8.

FIG. 11 is a generally perspective, fragmentamy rear view of the headrest of FIG. 8.

### DESCRIPTION OF THE INVENTION

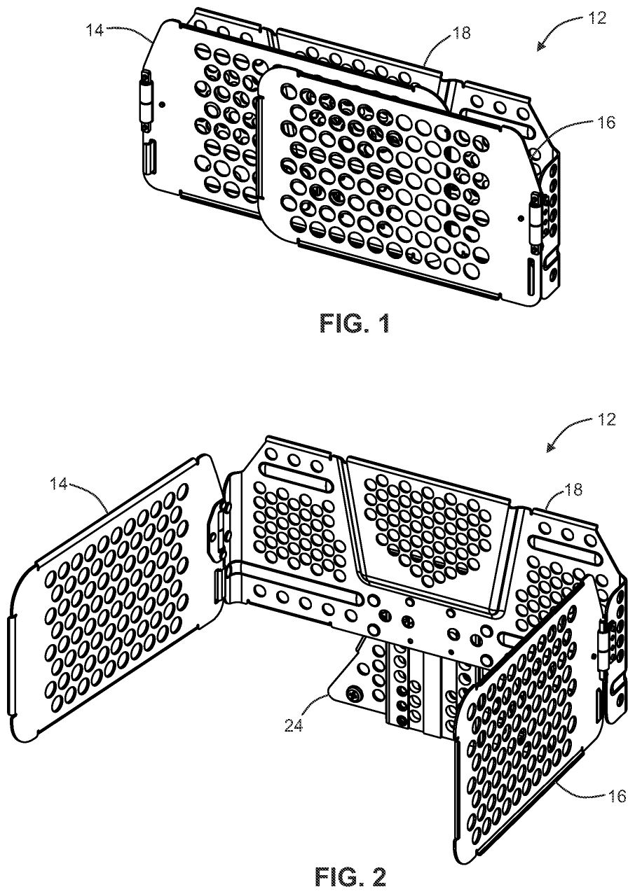

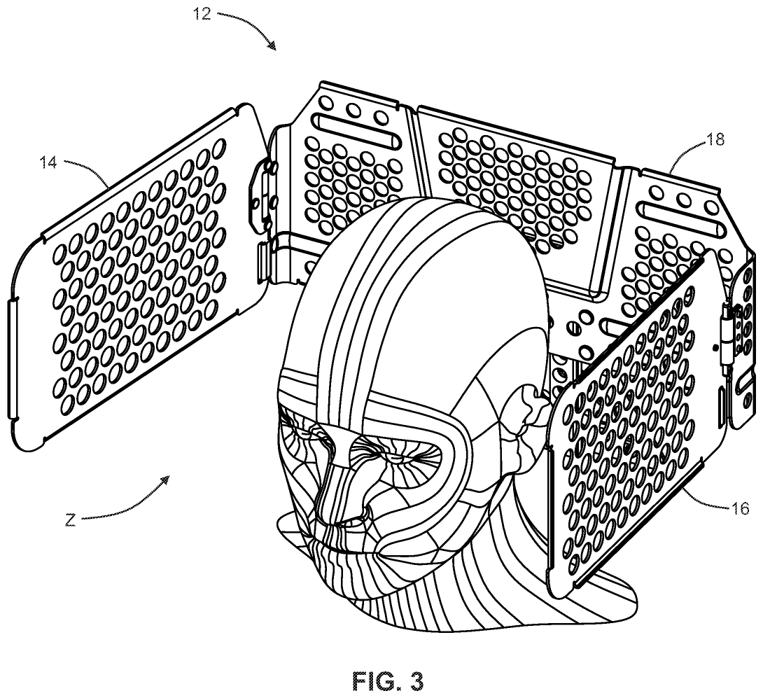

Referring to the drawings and particularly to FIGS. 1, 2 and 3, one form of the privacy/protective headrest of the invention is there illustrated and generally designated by numeral 12. The vertically adjustable headrest 12, which is suitable for use in connection with various types of passenger vehicles, including commercial aircraft, provides both support and comfort to the user. The headrest uniquely includes first and second privacy/protection head support wings 14 and 16 that are hingedly connected to a transverse support 18 for movement between the first stowed position shown in FIG. 1 wherein the support wings are overlapping, am parallel with and ae in close proximity with the transverse support, and the second deployed position shown in FIGS. 2 and 3 wherein the support wings extend outwardly from the transfer support at about 90 degrees to form a privacy zone.

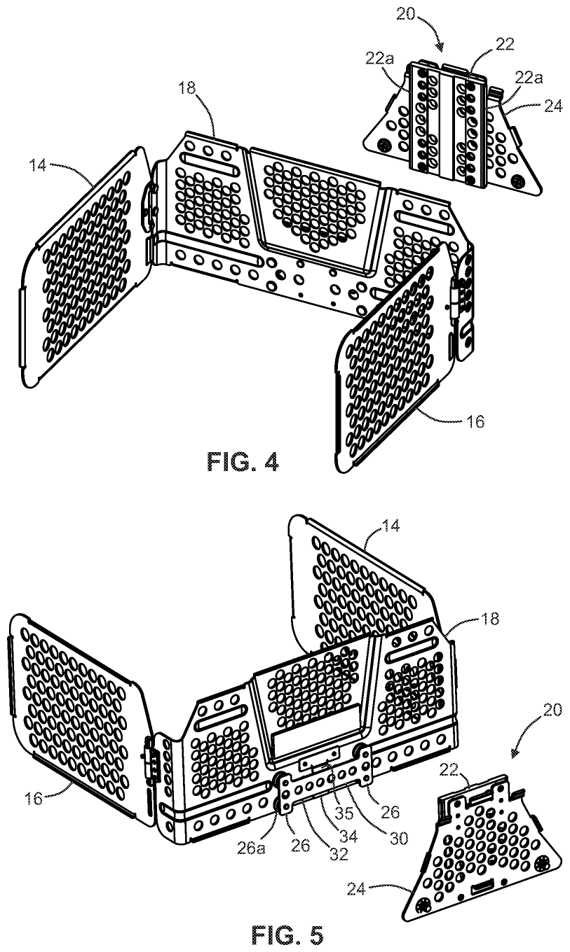

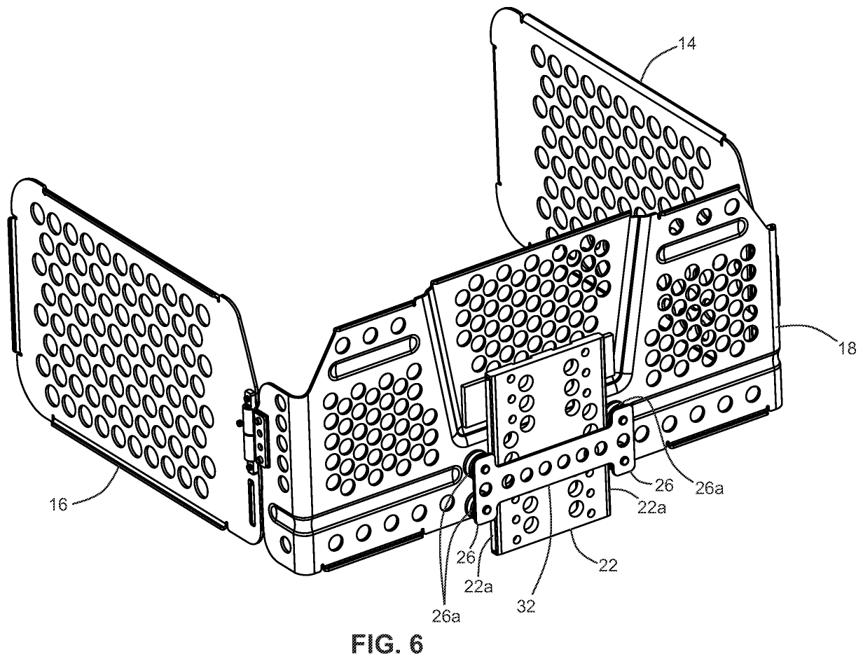

As illustrated in FIGS. 4 and 5 of the drawings, the seat headrest also includes a mounting assembly 20 that can be connected to the vehicle seat by any suitable means. As best sea in FIG. 4, mounting assembly 20 comprises an elongated guide 22 and a seat connector plate 24 that can be connected to the vehicle seat by suitable connectors. Elongated guide 22 includes oppositely disposed guide rails 22a which, in a manner presently to be described, are adapted to be rollably engaged by two sets of transversely spaced apart roller assemblies 26 (FIG. 6) that e mounted on central head support plate 18 (see FIG. 5). The roller assemblies 26, each of which me of identical construction, include grooved rollers 26a that roll along guide rails 22a so that the mounting assembly 20 can be adjustably moved upwardly and downwardly so as to enable the desired adjustment in the height of the support assembly. A transversely extending connector member 30 spans the spaced apart rollers in the manner illustrated in FIG. 5 and defines a guide channel 32 within which guide 22 is disposed.

Forming an important aspect of the headrest assembly of this latest form of the invention is a resistance imparting means for imparting resistance to the movement of support assembly 20 upwardly and downwardly relative to guide 22. In the present form of the invention, this novel resistance imparting assembly comprises a uniquely configured, generally T-shaped leaf spring designated in the drawings by the numeral 34 (see FIG. 5). As best seen in FIG. 6, spring 34 includes a transverse connector portion that is affixed to central head support panel 18 and a downwardly extending, curved central portion 35 that extends into channel 32. When the support assembly 20 is mounted on guide 22 in the manner shown in FIG. 6, the curved central portion of the spring will be yieldably deformed so that it is brought into pressural engagement with the guide. With this construction, as the headrest assembly is moved upwardly and downwardly, the central portion of the spring will frictionally engage the surface of guide 22 and will yieldably resist sliding movement of support assembly 20.

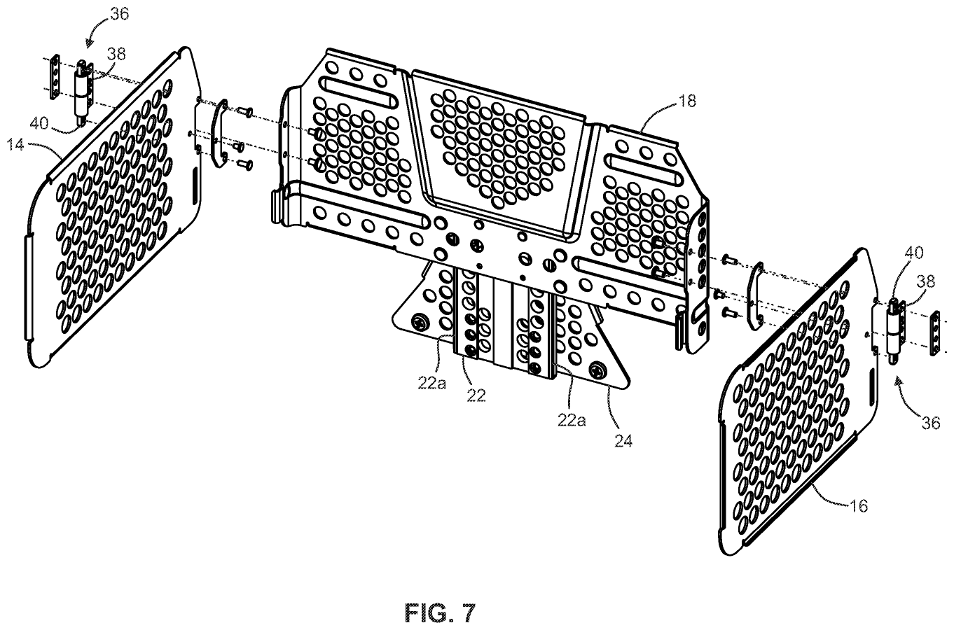

In using the headrest assembly of the invention, the central head portion panel 18 and the adjustable wing like supports 14 and 16 are covered with an appropriate padding and the seat connector plate 24 is connected to the vehicle seat by any type of suitable connectors. This done, the wing like supports can be folded from the overlapping stowed position shown in FIG. 1 of the drawings into the 90 degree outward position shown in FIG. 3. In this regard, as previously mentioned, the adjustable wings are pivotally connected to transverse panel 18 by means of friction hinge assemblies 36 (see FIGS. 1, 2, and 7). Friction hinge assemblies 36, each of which includes a connector bracket 38, a shaft portion 40 carried by the connector bracket, and a friction imparting clip disposed in frictional engagement with the shaft portion, are of conventional construction and are readily commercially available from various sources, including Reell Company of St Paul, Minn. and the Southco company of Concord, Pa.

As illustrated in FIG. 3 of the drawings, the central head portion panel 18 and the adjustable wing like supports 14 and 16 are of a strategic length that will create a privacy zone within which the users head can comfortably reside. More particularly, in the embodiment of the invention shown in FIG. 3, the central head portion panel 18 preferably has a length of between about 10.5 inches and about 11.5 inches and the wing like supports 14 and 16 preferably have a length of between about 9.6 inches and about 10.6 inches. Assuming the diameter of the head of a typical passenger to be on the order of 8% inches, it can be seen in FIG. 3 of the drawings that when the passenger is seated in the passenger seat, the head portion is comfortably disposed within the privacy zone “Z” defined by the central head portion panel 18 and the wing like supports 14 and 16.

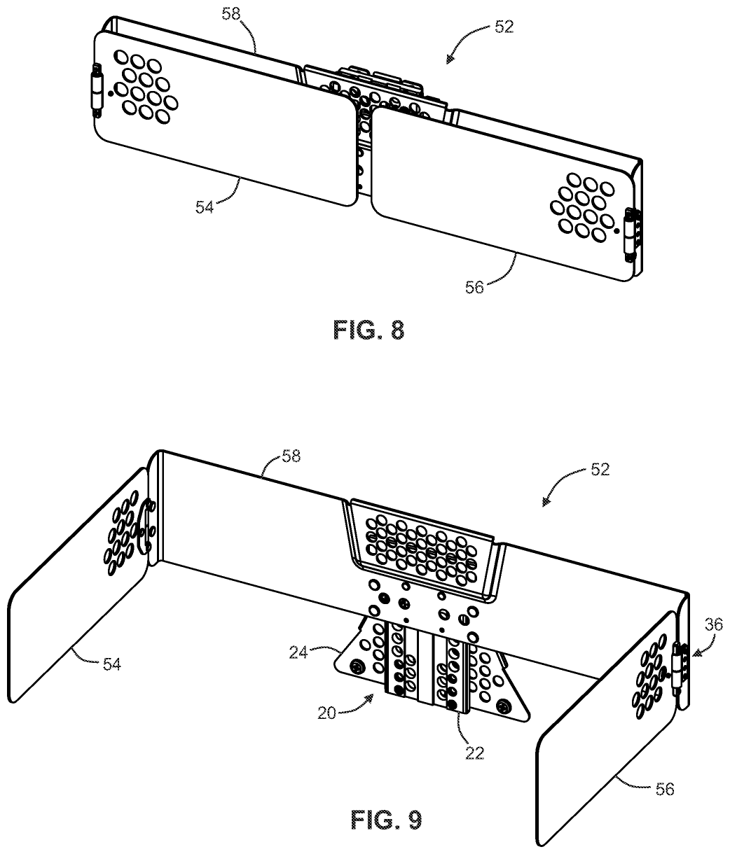

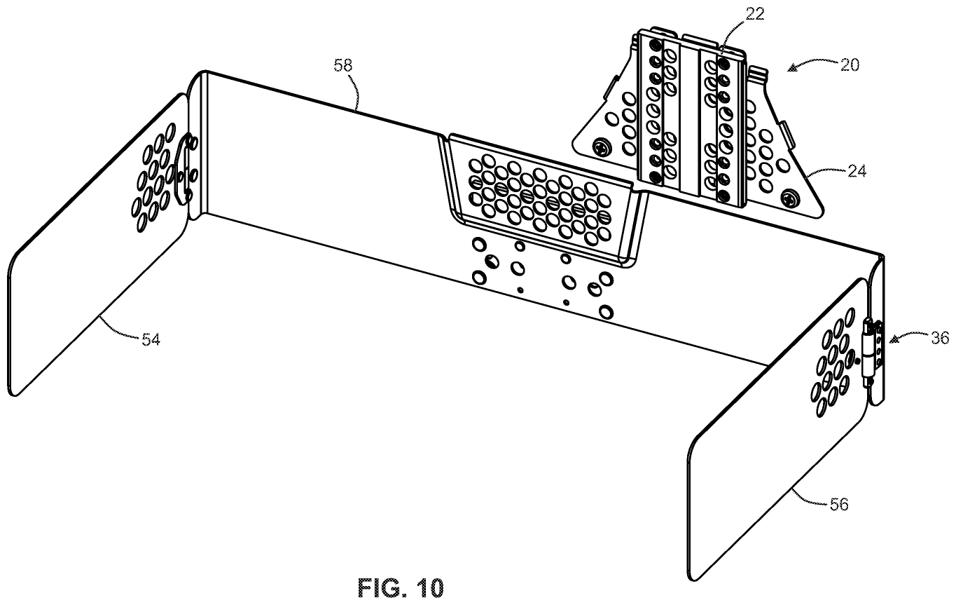

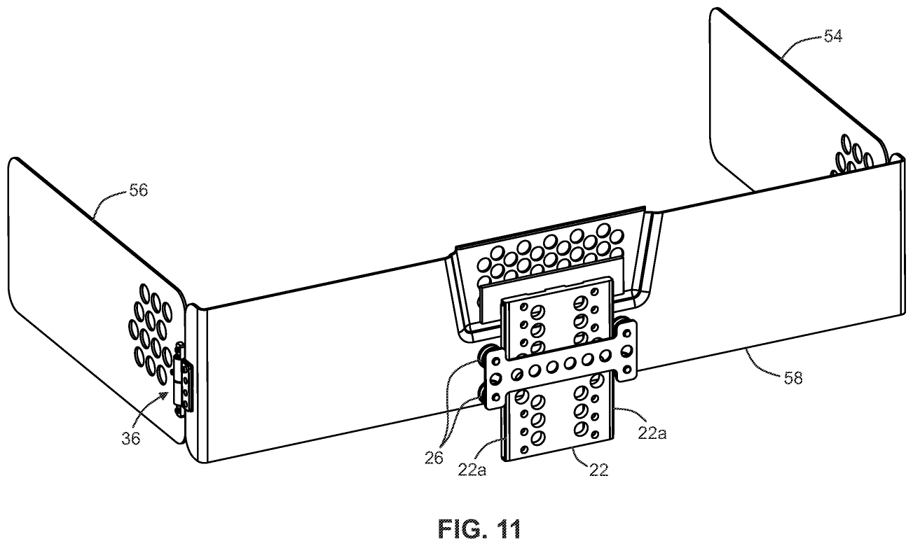

Referring next to FIGS. 8 and 9 of the drawings, an alternate form of the privacy/protective headrest of the invention is there illustrated and identified by the numeral 52. This form of the invention is similar in many respects to the previously described embodiment and like numerals are used in FIGS. 8, 9, 10, and 11 to identify like components. The primary difference between this latest embodiment of the invention and the embodiment illustrated in FIGS. 1 through 7 of the drawings resides in the differently configured privacy/protection head support wings 54 and 56 and the transverse support 58. As best seen in FIG. 10, the headrest of this latest form of the invention also includes a mourning assembly 20 that is substantially identical in construction and operation to the mounting assembly shown in FIGS. 1 through 7 of the drawings. The headrest of this latest form of the invention also includes two sets of transversely spaced apart roller assemblies 26 that are mounted on transverse support 58 (see FIG. 11). As before, the roller assemblies 26, each of which are of identical construction, include grooved rollers 26a that roll along guide rails 22a so that the mounting assembly 20 can be adjustably moved upwardly and downwardly. As in the carrier described embodiment of the invention, this latest form of the invention includes a resistance imparting means for imparting resistance to the movement of support assembly 20 upwardly and downwardly relative to guide 22. As before this novel resistance imparting assembly comprises a uniquely configured, generally T-shaped leaf spring that is connected to central head support 58.

As in the earlier described embodiment of the privacy/protective headrest, the central head portion panel 58 and the adjustable wing like supports 54 and 56 are of a strategic length that will create a privacy zone within which the user head can comfortably reside. More particularly, in this latest embodiment of the invention, the central head portion panel or transverse support 58 preferably has a length of between about 19 inches and about 21 inches and the wing like supports 54 and 56 preferably have a length of between about 9.6 inches and about 10.6 inches. Assuming the diameter of the head of a typical passenger to be on the order of 8 M inches, when the passenger is seated in the passenger seat, the head portion is comfortably disposed within the privacy zone “X” defined by the central head portion panel 58 and the wing like supports 54 and 56. As best seen in FIGS. 8 and 9, wing-like supports 54 and 56 are moveable between the stowed position shown in FIG. 8 wherein the wings are parallel with and in close proximity to the central head portion panel or transverse support 58 and the extended position shown in FIG. 9 wherein the wings extend outwardly by about 90 degrees.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention as set forth in the following claims.

We claim:

1. A privacy/protective seat headrest assembly interconnectable with a seat comprising:
(a) a mounting assembly;
(b) a transverse support connected to said mounting assembly; and
(c) first and second privacy head support wings hingedly connected to said transverse support for movement between a first stowed position wherein said support wings are parallel with and ae in close proximity with said transverse support and a second deployed position wherein said support wings extend outwardly from said transfer support to form a privacy zone.

2. The seat headrest assembly as defined in claim 1 in which said first and second privacy head support wings are hingedly connected to said transverse support for movement between a first stowed position wherein said support wings overlap and a second deployed position wherein said support wings extend outwardly from said transfer support to form a privacy zone.

3. The seat headrest assembly as defined in claim 1 in which said first and second privacy head support wings are hingedly connected to said transverse support for movement between a first stowed position wherein said support wings overlap and are in close proximity with said transverse support and a second deployed position wherein said support wings extend outwardly from said transfer support at an angle of about 90° to form a privacy zone.

4. The seat headrest assembly as defined in claim 1 in which said mounting assembly comprises a connector plate adapted to be connected to the seat and an elongated guide having oppositely disposed guide rails.

5. The seat headrest assembly as defined in claim 4 further including two sets of transversely spaced apart roller assemblies connected to said transverse support and disposed in rollable engagement with said elongated guide.

6. The seat headrest assembly a defined in claim 5 in which each of said two sets of transversely spaced apart roller assemblies include grooved rollers constructed and arranged to rollably engage said oppositely disposed guide rails of said elongated guide for permitting movement of said transverse support between a first lowered position and a second raised position.

7. The seat headrest assembly as defined in claim 6 further including resistance imparting means connected to said transverse support for imparting resistance to the movement of said transverse support between said first lowered position and said second raised position.

8. The privacy/protective seat headrest assembly as defined in claim 7 in which said resistance imparting means comprises a generally T-shaped leaf spring connected to said transverse support.

9. The privacy/protective seat headrest assembly as defined in claim 7 in which said transverse support has a length of between about 10.5 inches and about 11.5 inches.

10. The privacy/protective seat headrest assembly as defined in claim 9 in which each of said first and second privacy head support wings have a length of between about 9.6 inches and about 10.6 inches.

11. A privacy/protective seat headrest assembly interconnectable with a seat comprising:
(a) a mounting assembly comprising:
(i) a connector plate adapted to be connected to the seat; and
(ii) an elongated guide having oppositely disposed guide rails;
(b) a transverse support connected to said mounting assembly;
(c) a plurality of transversely spaced apt roller assemblies connected to said transverse support and disposed in rollable engagement with said guide rails of said elongated guide of said mounting assembly for permitting movement of said transverse support between a first lowered position and a second raised position; and
(d) first and second privacy head support wings hingedly connected to said transverse support for movement between a first stowed position wherein said support wings are parallel with and are in close proximity with said transverse support and a second deployed position wherein said support wings extend outwardly from said transfer support to form a privacy zone.

12. The seat headrest assembly as defined in claim 11 in which said second deployed position said first and second privacy head support wings extend outwardly from said transfer support at an angle of about 90 degrees.

13. The seat headrest assembly a defined in claim 11 further including resistance imparting means connected to said transverse support for imparting resistance to the movement of said transverse support between said first lowered position and said second raised position.

14. The privacy/protective seat headrest assembly as defined in claim 13 in which said resistance imparting means comprises a generally T-shaped leaf spring connected to said transverse support.

15. The privacy/protective seat headrest assembly as defined in claim 13 in which said transverse support has a length of between about 19 inches and about 21 inches and in which each of said first and second privacy head support wings have a length of between about 9.6 inches and about 10.6 inches.

16. A privacy/protective seat headrest assembly interconnectable with a seat comprising:
(a) a mounting assembly comprising:
(i) a connector plate adapted to be connected to the seat; and
(ii) an elongated guide having oppositely disposed guide rails;
(b) a transverse support connected to said mounting assembly;
(c) a plurality of transversely spaced apart roller assemblies connected to said transverse support and disposed in rollable engagement with said guide rails of said elongated guide of said mounting assembly for permitting movement of said transverse support between a first lowered position and a second raised position;
(d) resistance imparting means connected to said transverse support for imparting resistance to the movement of said transverse support between said first lowered position and said second raised position; and
(e) first and second privacy head support wings hingedly connected to said transverse support for movement between a first stowed position wherein said support wings ae parallel with and are in close proximity with said transverse support and a second deployed position wherein said support wings extend outwardly from said transfer support at an angle of about 90 degrees to form a privacy zone.

17. The privacy/protective seat headrest assembly as defined in claim 16 in which said resistance imparting means comprises a generally T-shaped leaf spring connected to said transverse support.

18. The privacy/protective seat headrest assembly as defined in claim 16 in which said transverse support has a length of between about 10.5 inches and about 11.5 inches.

19. The privacy/protective seat headrest assembly as defined in claim 18 in which said each of said first and second privacy head support wings has a length of between about 9.6 inches and about 10.6 inches.

20. The privacy/protective seat headrest assembly as defined in claim 18 in which said transverse support has a length of between about 19 inches and about 21 inches.
